(19) United States
(12) Patent Application Publication
(10) Pub. No.: US 2002/0113428 A1
(43) Pub. Date: Aug. 22, 2002

(54) Shipping label with a hidden protected packing slip

(76) Inventors: Nikki Phillips, Overland Park, KS (US); Craig Davidson, Coldwater, MI (US); Richard L. Romine JR., Angola, IN (US); Doug Lanning, Angola, IN (US)

Correspondence Address: Patrick J. Tracy, Hodgson Russ LLP, One M&T Plaza, Suite 2000, Buffalo, NY, 14203-2391, US

(21) Appl. No.: 09/791,508

(22) Filed: Feb. 22, 2001

(51) Int. Cl. B42D 15/00

(52) U.S. Cl. 283/62

(57) ABSTRACT

The present invention is directed to a combined packing slip and shipping label provided into one form. The shipping label is attached to the packing slip along a line of perforation. The packing slip is provided with adhesive on three of its perimeter sides for securing it to a liner material. An interior portion of the packing slip, bordered by the three adhesive sides, is devoid of adhesive. When the packing slip is folded along a line of perforation, it is disposed intermediate the shipping label and the liner. Perforations also delineate the interior of the packing slip from the three sides of adhesive for removing the packing slip therefrom. Also, a remote end of the packing label opposite the packing slip is adhered to the liner. This construction maintains the remote end of the shipping label secured to the liner as the combined form is run through a printing device.

### BACKGROUND OF THE INVENTION

1. Field of the Invention

The present invention relates to a combined packing slip and shipping label provided in one form.

2. Prior Art

There has been a need to develop a packing slip label combination which can be used without a further enclosure such as a packing sleeve. Previous attempts in this area have produced questionable results since, in many cases, the packing slip can be lost or damaged when attempting to recover packing slips from shipped containers. Recovery has been difficult since the packing slip does not easily separate from the label or is torn. The prior art discloses previous attempts in this area.

Turning now to the patents, U.S. Pat. No. 5,659,987 to Scheggetman relates to a multi-portion label including a first portion and a second portion separable from each other by a line of perforations. The second portion includes a fold line spaced from the perforation line. The first portion includes adhesive on three edges thereof. The second portion is of a size such that when it is folded under the first portion about the fold line, the second portion does not contact the adhesive but is substantially disposed intermediate the first portion and a substrate to which the first portion is adhered. The current invention also includes a closing flap on the bottom side, further protecting the packing slip from the elements.

U.S. Pat. No. 5,730,469 to Heimerdinger et al. describes a unitary shipping label and packing list label including a printable surface divided into a first layer having a first printable area and a second printable area separable from one another by a common edge. The first layer further includes a border area substantially surrounding at least three sides of the first printable area and having an adhesive for adhering the first layer to a non-stick backing layer. The backing layer has a backing perforation extending therethrough to define a removable backing section that remains attached to the printable surface as the combination label is removed from a carrier strip. In use, the second printable area is folded beneath the first printable area when a first section of the backing layer is removed for connecting the combination shipping and packing list label to a support surface, such as a package. In the present invention, the liner sheet is not provided with perforations.

U.S. Pat. No. 5,776,571 to Michlin describes a combined form and label construction comprising a label portion with a glue frame on the back side for securement to a shipping container. In the embodiment shown, the form portion has a pair of glue strips disposed along a marginal strip. A backing sheet is releaseably secured to glue strips of the label portion while the marginal strips of the form portion remain adhered to the backing sheet. In use, the backing sheet is removed from the back side of the form with the marginal strips separating from the remainder of the form portion to peel off with the backing sheet. The remainder of the form portion is then folded beneath the face of the label portion so that when the label is secured to a support surface, the form portion lies intermediate the label portion and the support surface. In the present invention, the shipping label is not provided with adhesive on its side edges.

### SUMMARY OF THE INVENTION

The present invention is directed to a combined packing slip and shipping label provided into one form. The shipping label is attached to the packing slip along a line of perforations. The packing slip is provided with adhesive on three of its perimeter sides for securing it to a liner material. An interior portion of the packing slip, bordered by the three adhesive sides, is devoid of adhesive. When the packing slip is folded along a line of perforations, it is disposed intermediate the shipping label and the liner. Perforations also delineate the interior of the packing slip from the three sides of adhesive for removing the packing slip therefrom. Also, a remote end of the packing label opposite the packing slip is adhered to the liner. This construction maintains the remote end of the shipping label secured to the liner as the combined form is run through a printing device.

The foregoing and additional advantages and characterizing features of the present invention will become clearly apparent upon reading of the ensuing description together with the included drawings wherein:

### BRIEF DESCRIPTION OF THE DRAWINGS

FIG. 1 is a plan view of the three-part label form attached to a release liner.

FIG. 2 shows a section cut along axis 2-2 in FIG. 1 depicting the first portion or shipping label attached to the release liner.

FIG. 3 shows a section cut along axis 3-3 in FIG. 1 showing the relation of the second portion or packing slip in relation to the release liner in the absence of adhesive.

FIG. 4 shows a section cut along axis 4-4 in FIG. 1 showing the relation of the tongue of the packing slip portion attached to the release liner.

FIG. 5 shows a section cut along axis 5-5 in FIG. 1. showing the relation of the third portion of the label attached to the release liner.

FIG. 6 is a perspective view showing attachment of the label to a package surface.

FIG. 7 shows a section cut along axis 7-7 in FIG. 6 showing the packing slip disposed between the label and the package surface.

FIG. 8 is a perspective view showing removal of the packing slip from the attached label.

FIG. 9 is a perspective view showing the removed label with packing slip attached.

FIG. 10 is a perspective view showing detaching the packing slip from the mailing label.

### BEST MODE FOR CARRYING OUT THE INVENTION

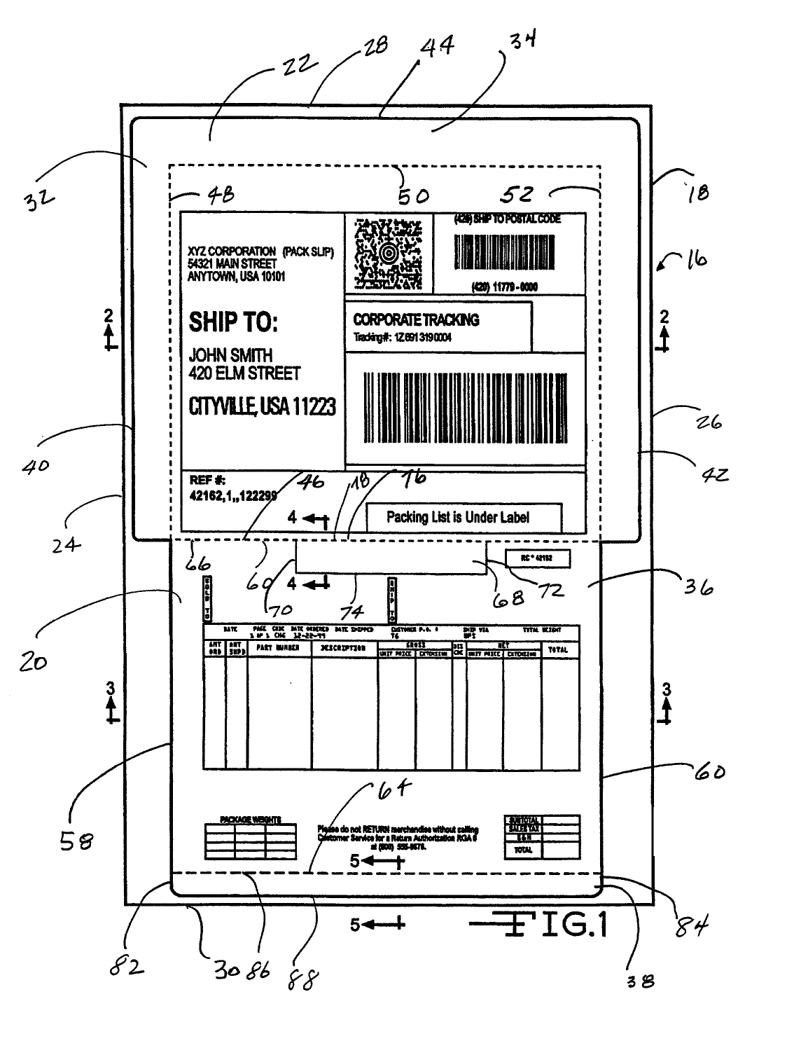

Now turning to the drawings, FIG. 1 shows the shipping label-packing slip combination 16 according to the present invention. The combination form 16 is a three portion label attached to a release liner 18. It can be appreciated by those skilled in the art that an optimum grade of paper can be used to construct the main body 20. The preferred type of paper is thermal transfer, although others may be satisfactory. The face 22 of the combination is suitable for printing with a laser or other printer.

Now in FIGS. 1 through 5, the combination form consists of a release liner 18 having spaced apart left and right edges 24 and 26 extending upward to and meeting with upper edge 28, and further extending downward and meeting with lower edge 30.

Attached to the release liner 18, is a three part shipping label-packing slip combination 32, consisting of first, second and third parts 34, 36, and 38. The first part 32, the shipping label, consists of spaced apart left and right side edges 40 and 42 extending to and meeting with upper edge 44 at rounded corners. The left and right side edges 40 and 42 further extend downwardly and meet with lower edge 46 at rounded corners. Side edges 40 and 42 are parallel to each other and perpendicular to both upper and lower edges 44 and 46. The first part 34 also contains first, second and third lines of perforations 48, 50 and 52. Lines 48 and 52 are spaced inwardly and parallel to left and right side edges 40 and 42 and are perpendicular to upper and lower edge 44 and 46. Perforation lines 48 and 52 extend upwardly from lower edge 46 and meet with the third perforation line 50. Perforation line 50 is smaller than upper edge 44 and spaced inwardly therefrom. Perforation line 50 is parallel to upper edge 44 and perpendicular to perforation lines 48 and 52.

As shown in FIG. 2, the first portion of the packing label 34 is attached to the release liner 18 by adhesive 54 located on the exterior part of label defined as the area between perforated lines 48, 50, and 52 and the left and right side edges 40 and 42 and upper edge 44. The interior portion of the label 56, defined by perforation lines 48, 50, and 52, and lower edge 46, is devoid of adhesive.

The second portion 36 of the form, the packing slip, consists of spaced apart left and right side edges 58 and 60 extending to and meeting with upper edge 62. Upper edge 62 is smaller than lower edge 46 and spaced inward from the label left and right edges 40 and 42. The left and right side edges 58 and 60 further extend to and meet with lower edge 64. Upper edge 60 of the packing slip 36, is connected to lower edge 46 by a fourth perforated line 66. The second portion 36 is not attached to the release liner by an adhesive (FIG. 3). Side edges 58 and 60 are perpendicular to upper and lower edges 60 and 64, and are parallel to each other. The second portion 36 is attached to the first portion 34 of the label 32 by the fourth line of perforations 66.

Extending downwardly from upper edge 60 of the second portion 36 is a flap 68. Flap 68, which is die cut at the time the label is produced, includes spaced apart left and right edges 70 and 72 extending to and meeting with flap lower edge 74. The left edge of flap 70 is parallel to the left edge of the second portion 58 and spaced inwardly therefrom. Similarly, the right edge 72 is parallel to the right edge of the second portion 60 and is spaced inwardly therefrom. The lower edge 74 of the flap 68 is generally parallel to the upper and lower edges 64 and 66 of the second portion 36, and perpendicular to flap left and right side edges 70 and 72. The upper edge 76 of flap 68 is attached to the first part 34 by a fifth line of perforations 78. The fifth line 78 is smaller than the fourth line of perforations 66 and contained therein, centered about the vertical axis of the label 34. The flap 68 is attached to the release liner 30 by adhesive 80 (FIG. 4).

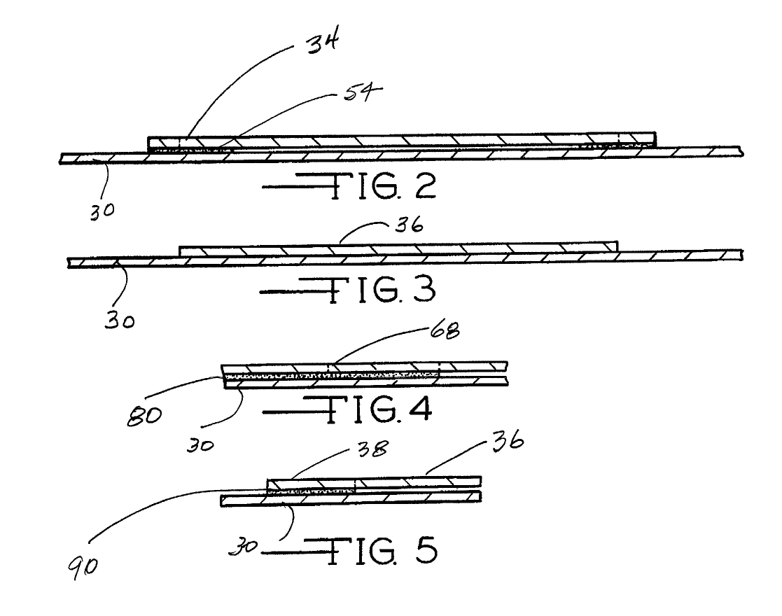

The third portion is the remote end of the label or the connecting tab 38. The connecting tab 38 is defined by spaced apart left and right side edges 82 and 84 extending to and meeting with upper edge 86, and extending further downward and meeting with lower edge 88 at rounded corners. Upper and lower edges 86 and 88 are parallel and both are perpendicular to left and right side edges 82 and 84. The third portion of the label 38 is attached to the second portion by a sixth line of perforations 92. The third portion 38 is attached to the release liner 30 by adhesive 90, as shown in FIG. 5. The third portion 38 maintains the remote end secured to the liner 18 as the form 16 is run through a printing device (not shown).

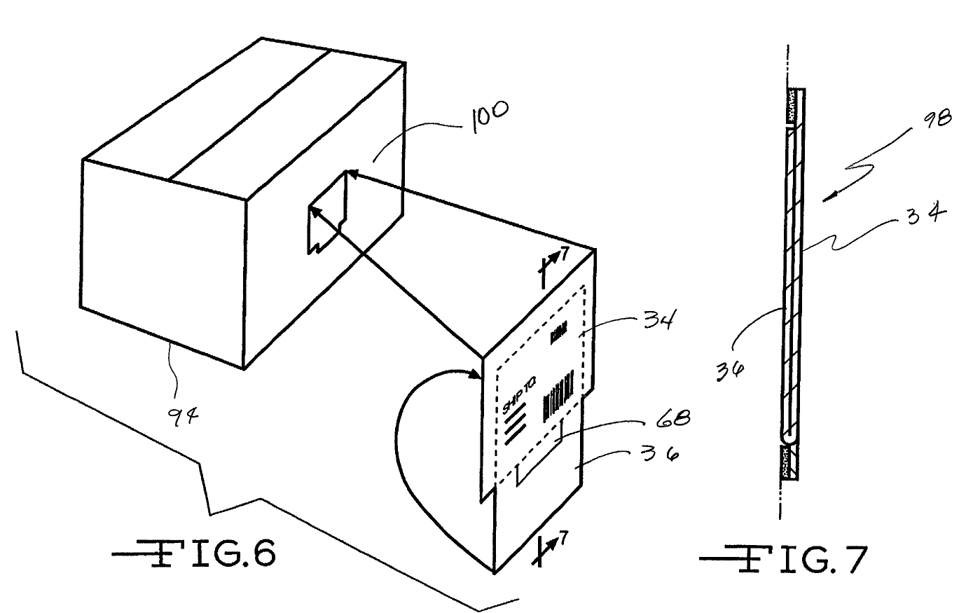

The pertinent shipping information can be imprinted to the face of the label 22 by using a laser or other such similar printer (not shown). To affix the label 34 to an object 94 as shown per FIG. 6, the first and second portions 34 and 36 are separated from the release liner 30 and separated from the third portion 38 by tearing along the sixth line of perforations. Although a box is shown as the object 94, it can be appreciated by those skilled in the art that the box is shown for illustrative purposes and the object could be anything which can be shipped.

As shown in FIG. 6, after the first and second portions 34 and 36 are removed from the release liner, the second portion 36 is folded under the label 34 along the first line of fold 96 creating folded assembly 98, leaving flap 68 coplanar with shipping label 34. Line of fold 96 is discontinuous but generally coincides with the fourth line of perforations 66. The folded assembly is then attached to the object to be shipped 94 by the adhesive on the exterior of the shipping label 54 and the adhesive attached on the flap of the second portion 80.

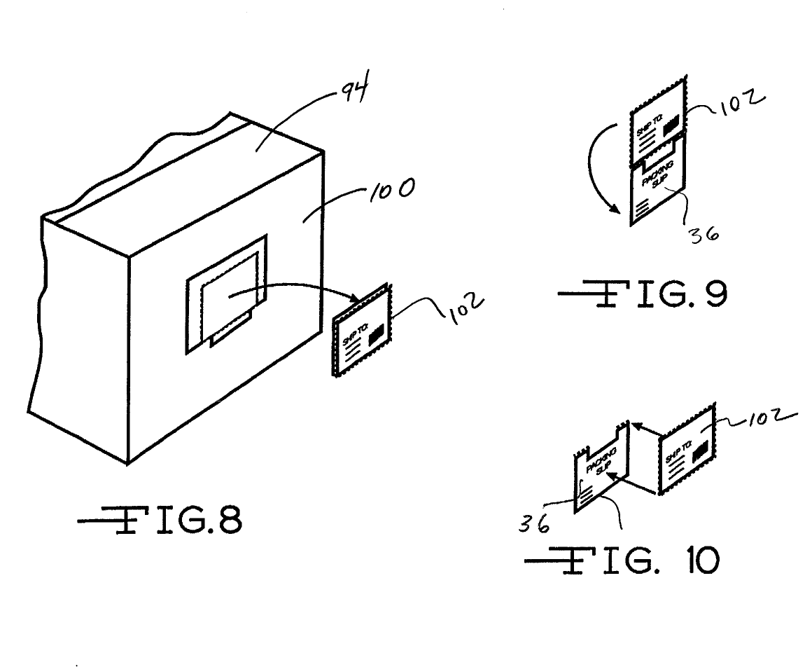

Now in FIGS. 7 through 10, in the fully closed position, the packing slip 36 is disposed between the shipping label 34 and the surface 100 of the object to be shipped 94. The packing slip 36 is protected and may be easily recovered if necessary. To recover the packing slip 36, the label portion 102 defined by first, second, and third lines of perforations 48, 50, 52, and packing slip upper edge 62, is scored along the first, second, third and fifth lines of perforations 48, 50, 52 and 78 and removed, revealing the packing slip 36 attached to the label portion 102. The packing slip 36 can be easily separated from the shipping label portion 102 by tearing along the fourth line of perforations 66.

While the preferred embodiment of the present invention has been disclosed, it will be appreciated that it is not limited thereto, but may be otherwise embodied within the scope of the following claims.

I claim:

1. A packing slip-shipping label combination form comprising:
(a) a liner;
(b) a shipping label, said label defined by interior and exterior portions, wherein said exterior portion is delineated from the interior portion of the shipping label by a first line of perforations which resides adjacent to left and right exterior edges and an upper edge of the shipping label, wherein said exterior portion is removably secured to the liner;
(c) a packing slip, said packing slip is connected to the interior portion of said shipping label by a second line of perforations, wherein said packing slip is devoid of adhesive and unsecured to the liner.
(d) a flap, said flap is connected to the shipping label and residing intermediate to the shipping label and the packing slip, wherein said flap is removably secured to the liner; and,
(e) a connecting tab, said tab is remote from the shipping label and connected to said packing slip by a third line of perforations and said tab is removably secured to the liner.

2. A packing slip-shipping label combination form according to claim 1, wherein the type of paper is thermal transfer.

3. The packing slip-shipping label combination form of claim 1 wherein the flap is connected to the shipping label by a fourth line of perforations.

4. A packing slip-shipping label form comprising:
(a) a liner;
(b) a shipping label, said label defined by interior and exterior portions, wherein said exterior portion is delineated from the interior portion of the shipping label by a first line of perforations which resides adjacent to left and right exterior edges and an upper edge of the shipping label, wherein said exterior portion is removably secured to the liner;
(c) a packing slip, said packing slip is connected to the interior portion of said shipping label by a second line of perforations, wherein said packing slip is devoid of adhesiveand unsecured to the liner; and,
(d) a connecting tab, said tab is remote from the shipping label and connected to said packing slip by a third line of perforations and said tab is removably secured to the liner.

5. A packing slip-shipping label combination form according to claim 4, said combination further comprising a flap, said flap is connected to the shipping label and residing intermediate to the shipping label and the packing slip, and said flap is removably secured to the liner.

6. A packing slip-shipping label form comprising:
(a) a liner;
(b) a shipping label, said label defined by interior and exterior portions, wherein said exterior portion is delineated from the interior portion of the shipping label by a first line of perforations which resides adjacent to left and right exterior edges and an upper edge of the shipping label, wherein said exterior portion is removably secured to the liner;
(c) a packing slip, said packing slip is connected to the interior portion of said shipping label by a second line of perforations, wherein said packing slip is devoid and unsecured to the liner; and,
(d) a flap, said flap is connected to the shipping label and residing intermediate to the shipping label and the packing slip, wherein said flap is removably secured to the liner.

7. A packing slip-shipping label combination form according to claim 6, further comprising a connecting tab, said tab is remote from the shipping label and connected to said packing slip by a third line of perforations and said tab is removably secured to the liner.

8. A method of shipping an object consisting of:
(a) providing a combination packing slip-shipping label combination form comprising
(i) a liner;
(ii) a shipping label, said label defined by interior and exterior portions, wherein said exterior portion is delineated from the interior portion of the shipping label by a first line of perforations which resides adjacent to left and right exterior edges and an upper edge of the shipping label, wherein said exterior portion is removably secured to the liner;
(iii)a packing slip, said packing slip is connected to the interior portion of said shipping label by a second line of perforations, wherein said packing slip is devoid of adhesive and unsecured to the liner.
(iv) a flap, said flap is connected to the shipping label and residing intermediate to the shipping label and the packing slip, wherein said flap is removably secured to the liner; and,
(v) a connecting tab, said tab is remote from the shipping label and connected to said packing slip by a third line of perforations and said tab is removably secured to the liner.
(b) printing information on the combined packing slip-shipping label combination form;
(c) attaching the shipping label wherein said shipping label-packing slip combination is detached from the connecting tab, and said packing slip is folded under said shipping label and secured by the exterior portion of the shipping label and the flap;
(d) recovering the packing slip, by scoring the perforation lines on the shipping label and on the flap, recovering the interior portion of the shipping label attached to the packing slip; and,
(e) separating the packing slip from the interior of the shipping label by tearing along the line of perforations separating thereto.
